(19) United States
(12) Patent Application Publication
(10) Pub. No.: US 2004/0141640 A1
(43) Pub. Date: Jul. 22, 2004

(54) Method for apparatus for detecting defects on a wafer

(76) Inventors: Byoung-Ho Lee, Gyeonggi-do (KR); Deok-Yong Kim, Gyeonggi-do (KR)

Correspondence Address: MARGER JOHNSON & McCOLLOM, P.C., 1030 S.W. Morrison Street, Portland, OR, 97205, US

(21) Appl. No.: 10/754,013

(22) Filed: Jan. 5, 2004

(30) Foreign Application Priority Data
Jan. 8, 2003 (KR) 2003-1103

(51) Int. Cl. G06K 9/00

(52) U.S. Cl. 382/149

(57) ABSTRACT

A light is irradiated on a wafer on which a plurality of cells are formed. Each cell includes a plurality of pixels. A gray level on each pixel is formed for every cell by sensing the light reflected from the wafer surface. The gray level of the killer defect can be formed by observing the wafer. The gray level of the killer defect is then respectively compared with the gray level on each pixel. The pixel having the gray level corresponding to that of the killer defect is checked to be defective. Therefore, the killer defect can be distinguished from the non-killer defects. As a result, the killer defect can be detected promptly and accurately, increasing the throughput.

### CROSS-REFERENCE OF RELATED APPLICATIONS

This application relies for priority upon Korean Patent Application No. 2003-1103 filed on Jan. 8, 2003, the contents of which are herein incorporated by reference in its entirety.

### BACKGROUND OF THE INVENTION

1. Field of the Invention

The present invention relates to a method and an apparatus for detecting a defect on a wafer.

2. Description of the Related Art

In general, fine patterns of semiconductor integrated circuits formed on a wafer need to be inspected for detecting pattern defects after performing a series of semiconductor fabrication process steps. As semiconductor devices become more highly integrated and a diameter of the wafer becomes larger, the inspection process for detecting a defect on the wafer is more frequently carried out. Therefore, overall manufacturing time for manufacturing the semiconductor device has been increased significantly, thereby raising manufacturing costs of the semiconductor devices.

Conventionally, an individual gray level corresponding to each of pixels on the wafer is measured, and the gray level of a target pixel and the gray levels of neighboring pixels adjacent to the target pixel are compared with each other. Then, the gray level difference is calculated. The inspection process detects the defect of the wafer by using the gray level difference. The inspection process is classified into an array mode and a random mode. While the array mode compares respective cells in a chip on the wafer for detecting defects on the wafer, the random mode compares respective dies for detecting defects. That is, the array mode detects the defects of the wafer by the cell, and the array mode detects the defects of the wafer by the chip. The array mode is usually used in a semiconductor memory device fabrication process, and the random mode is usually used in a logic device fabrication process. Hereinafter, the inspection process for detecting defects will be explained for the array mode.

The widespread array mode inspection process uses a threshold value for detecting defects on the wafer. The gray level difference between the target pixel and the neighboring pixels adjacent to the target pixel is compared with a preset threshold value. When the gray level difference is more than the preset threshold value, the target pixel is checked as a defective pixel. On the contrary, when the gray level difference is less than the threshold value, the target pixel is checked as a non-defective pixel.

Referring to FIG. 1, a wafer 12 on which a predetermined processing step has been carried out is loaded on a support 14 for detecting processing defects on the wafer. The wafer 12 is loaded/unloaded to/from the support 14 by conventional loading mechanisms such as a robot arm. A light source 10 irradiates a light to each cell on a surface of the wafer 12, and the light is reflected from the surface of the wafer 12. An image-detecting unit 16 such as a photo-sensor detects the reflected light to generate an analog image signal. The analog image signal is converted into a digital image signal of binary digits by an analog-to-digital converter (ADC). Thus, gray levels corresponding to respective pixels of each cell on the wafer are generated. The gray levels are processed as 8-bit digital signals, so that each pixel of the cell may have 256 kinds of gray levels. Therefore, gray levels corresponding to all of the pixels form digital images corresponding to a cell on the wafer, and all of the digital images for all of the cells form an image map corresponding to one sheet of the wafer. Then, a data processing unit 20 generates raw data of the target pixel. The raw data is a gray level difference between the gray level of the target pixel and the gray level of the neighboring pixel adjacent to the target pixel.

A threshold-presetting unit 24 presets a threshold value, which is used for judging whether there is a defect on the wafer. The raw data is calculated into an absolute value, and is compared with the threshold value. The defect on the wafer is detected by using a detecting unit 22. The detecting unit 22 includes a central processing unit (CPU) and a co-processor, and detects the defect on the wafer by using a main program and various sub-programs. The result of the detecting unit 22 is displayed on a monitor of the operating terminal 26.

Referring to FIG. 2, a light is irradiated on a first cell A that is an arbitrary cell on the wafer at an arbitrary time t0, and a first image I1 corresponding to the first cell A is obtained. Next, a light is irradiated on a second cell B adjacent to the first cell at a time t0+1 after a lapse of unit time from the time t0, and a second image I2 corresponding to the second cell B is obtained. A third image corresponding to the third cell, a fourth image corresponding to the fourth cell, and a fifth image corresponding to the fifth cell are sequentially obtained in the same manner. Thus the image map corresponding to an entire surface of the wafer is obtained. The size of the cell is determined such that the same pattern is repeated every image obtaining step. Each image is represented as the gray level of the pixels comprising the respective cells on the wafer, and the gray level is binary digital data. Therefore, an image difference I1-I2 between the first and second images is also the binary digital data.

FIG. 3 is a conceptual view explaining a process for detecting the defects on the wafer by using the detecting unit shown in FIG. 1. FIG. 3 shows arbitrary three cells adjacent to each other on the wafer for the sake of simplicity. The same alphabetic letter indicates a pixel located on the same position on different cells, and the same numeric letter indicates a substantially identical cell.

An experiment result shows that the gray levels of each pixel B1, B2, and B3 of the FIG. 3 are 50, 100, 50, respectively, and the gray levels of each pixel C1, C2, and C3 of the FIG. 3 are 60, 30, 60, respectively. That is, pixel B2 is more luminescent than pixels B1 and B3, and pixel C2 is less luminescent than pixels C1 and C3. The raw data of pixel B2 is the gray level difference between pixel B2 and the adjacent pixels B1 and B3. That is, the raw data of pixel B2 is calculated as the gray level difference of (gray level of pixel B2—gray level of pixel B1) and (gray level of pixel B2—gray level of pixel B3). In the same manner, the raw data of pixel C2 is calculated as the gray level difference of (gray level of C2—gray level of C1) and (gray level of C2—gray level of C3). According to the present experiment, the raw data of the B2 pixel is 50, and the raw data of pixel C2 is −30. The negative raw data is converted into the same positive value by being converted into an absolute value. If the threshold value is 40, pixel B2 is checked as a defective pixel and pixel C2 is checked as a non-defective pixel.

Referring to FIG. 4, a light is irradiated on a surface of the wafer on which a thin film is coated, and gray levels of each pixel on the wafer are generated in step S10. In next step S20, the raw data, the gray level difference between the target pixel and the neighboring pixel adjacent to the target pixel, is generated, and the threshold value, which is used for judging whether there is a defect on the wafer after compared with the raw data, is preset in step S30. In step S40, the raw data is checked whether or not the value is negative. If the value of the raw data is negative, the raw data is converted into a positive value by using the absolute value of the negative raw data at step S42. Subsequently, the raw data is compared with the threshold value in step S50, and the target pixel is checked as a defective pixel in step S60 if the value of the raw data is greater than the threshold value.

However, the conventional detecting method has several problems. For example, first, when the raw data of neighboring pixels adjacent to the target pixel are much alike in value, a killer defect, i.e., a serious defect, is generally detected together with a non-killer defect, i.e., a non-serious defect, such as a false defect due to an interference of light or a shape difference of the pixels. A cobalt silicide defect (“CoSi defect”), a kind of killer defect generated during a cobalt silicidation process, is one such example.

The CoSi defect is known to be difficult to be detected by conventional inspection devices. However, this is not because it is difficult to detect the pixel with the CoSi defect using an existing technology, but because other non-killer defects of which raw data are much similar in value to those of the pixel with the CoSi defect are undesirably detected together with the CoSi defect. Thus, there is a difficulty in distinguishing between the non-killer defects and the CoSi defect.

FIG. 5 is a view showing different kinds of defects detected together. Referring to FIG. 5, four different defects are detected together due to the similar raw data in value thereof. The difference between color strength in FIG. 5 indicates the difference between the raw data thereof. That is, the color strengths of the first and second defects 1a and 1b are similar to each other, and the color strength of the third and fourth defects 2a and 2b are also similar to each other. Therefore, the raw data of the first and second defects 1a and 1b are much alike in value, and the raw data of the third and fourth defects 2a and 2b are also much alike in value. Because the conventional detecting method detects the target pixel as a defective pixel whenever the raw data of the target pixel is greater than the threshold value, the first defect 1a is usually detected together with the second defect 1b, and third defect 2a is usually detected together with the fourth defect 2b. Assume that the first and third defects 1a and 2a are a killer defect, and the second and fourth defects 1b and 2b are a non-killer defect. It is difficult to distinguish the killer defect from the non-killer defect. As a result, the detection time and cost can be significantly increased. Particularly, when the non-killer defect is detected much more than the killer defect, the detection time and cost substantially reduces the throughput of the semiconductor device fabrication. The productivity reduction is much noticeable just as a design rule, which means a space tolerance between devices and interconnecting lines and the width of the lines themselves, shrinks more and more because the non-killer defect is detected all the better with the shrinkage of the design rule.

However, empirical results show that some killer defects are intensively detected around a particular gray level, and the detected defect sizes are distributed in particular range according to the kind of defect.

FIG. 6 is a photograph illustrating an exemplary defect detected around a particular gray level. As an example of the killer defect, a void defect 10 generated during a shallow trench isolation process is shown in FIG. 6. The void defect shown in FIG. 6 is a photograph taken by using an in-line scanning electron microscope (ILS). As shown in FIG. 6, the void defect 10 has a characteristic gray level distinctive from the neighboring gray level. The photograph of FIG. 6 confirms that some killer defects are intensively detected around a particular gray level.

### SUMMARY OF THE INVENTION

Accordingly, the present invention provides a method and an apparatus for preventing killer defects from being detected together with non-killer defects by using a characteristic gray level of the killer defects.

According to an embodiment of the present invention, a method of detecting a defect on a substrate is provided. A light is irradiated on a substrate on which a plurality of device units is formed. Each of the device units includes a plurality of pixels. Then, a reflected light reflected from the surface of the substrate is sensed, and first image data on each pixel is formed for every device unit. The first image data is compared with second image data on a specific defect. The surface of the substrate is reviewed or observed to generate the second image data. When the first image data is substantially identical to the second image data, the pixel corresponding to the first image data is checked as a defective pixel. The defective pixel and a defect image corresponding to the second image data may be displayed on a monitor.

According to another embodiment of the present invention, a method of detecting a defect on a substrate is provided. A light is irradiated on a substrate on which a plurality of device units is formed. Each of the device units includes a plurality of pixels. Then, a reflected light reflected from the surface of the substrate is sensed, and image data on each pixel is formed for every device unit. First differential image data of a target pixel is formed by subtracting the image data of a corresponding pixel from the image data of the target pixel. The target pixel is a subject pixel for detecting a defect. The corresponding pixel is a neighboring pixel that is positioned in a first device unit that is adjacent to a second device unit that includes the target pixel and corresponds to the target pixel. Then, the first differential image data is compared with a preset threshold value, and the first differential image data greater than the threshold value becomes second differential image data. A defect size of the target pixel corresponding to the second differential image data is compared with a reference size range of a specific defect, and the second differential image data of the target pixel of which the defect size is included in the reference size range becomes third differential image data. Finally, the target pixel corresponding to the third differential image data is checked as a defective pixel. The defective pixel and a defect image corresponding to the third image data may be displayed on a monitor.

According to still another embodiment of the present invention, there is provided an apparatus for detecting a defect on a substrate comprising: a support for supporting a substrate, a light source for irradiating a light onto the substrate surface, an image detector for detecting a reflecting light reflected from the substrate surface, an analog-to-digital converter, a data processing unit for forming first differential image data of a target pixel, a reference setting unit for setting a threshold value and a reference size range, and a checking unit for checking a defective pixel. A plurality of device units formed on the substrate surface may have a same pattern, and each of the device units includes a plurality of pixels. The image detector generates analog image data every pixel on the device unit. The analog-to-digital converter converts the analog image data to digital image data. The data processing unit subtracts the digital image data of a corresponding pixel from the digital image data of the target pixel. The target pixel is a subject pixel for detecting a defect. The corresponding pixel is a neighboring pixel that is positioned in a first device unit adjacent to a second device unit that includes the target pixel and that corresponds to the target pixel. The threshold value is compared with the first differential image data and the reference size range is compared with a defect size corresponding to a specific defect. The first differential image data greater than the threshold value becomes second differential image data of the target pixel. Second differential image data of the target pixel of which the defect size is included in the reference size range becomes third differential image data of the target pixel. The checking unit checks the target pixel corresponding to the third differential image data as the defective pixel.

According to yet another embodiment of the present invention, there is provided an apparatus for detecting a defect on a substrate comprising: a support for supporting a substrate, a light source for irradiating a light onto the substrate surface, an image detector for detecting a reflecting light reflected from the substrate surface, an analog-to-digital converter, a reference setting unit for setting a threshold value, and a checking unit for checking a defective pixel.

In view of the above exemplary embodiments, the killer defect and the non-killer defect can be prevented from being detected together.

### BRIEF DESCRIPTION OF THE DRAWINGS

The above and other objects and advantages of the present invention will become readily apparent by reference to the following detailed description when considering in conjunction with the accompanying drawings, in which:

FIG. 1 is a schematic view for showing a structure of a conventional inspector;

FIG. 2 is a schematic view for explaining the generation of the raw data by the data processing unit shown in FIG. 1;

FIG. 3 is a schematic view for explaining a process for detecting the defect on the wafer by using the detecting unit shown in FIG. 1;

FIG. 4 is a flow chart illustrating a conventional method of detecting a defect on the wafer;

FIG. 5 is a view showing different kinds of defects detected together due to the similar raw data;

FIG. 6 is a photograph illustrating an exemplary defect detected around a particular gray level;

FIG. 7 is a flow chart for illustrating a method of detecting a defect on a substrate according to a first embodiment of the present invention;

FIG. 8 is a flow chart for illustrating a method of detecting a defect on a substrate according to a second embodiment of the present invention;

FIG. 9 is a schematic view showing a structure of an apparatus for detecting a defect according to a first embodiment of the present invention; and

FIG. 10 is a schematic view showing a structure of an apparatus for detecting a defect according to a second embodiment of the present invention.

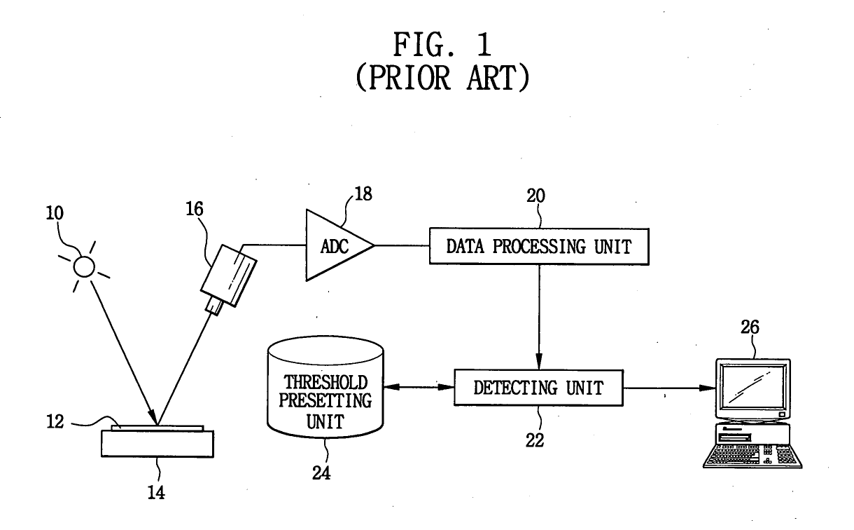

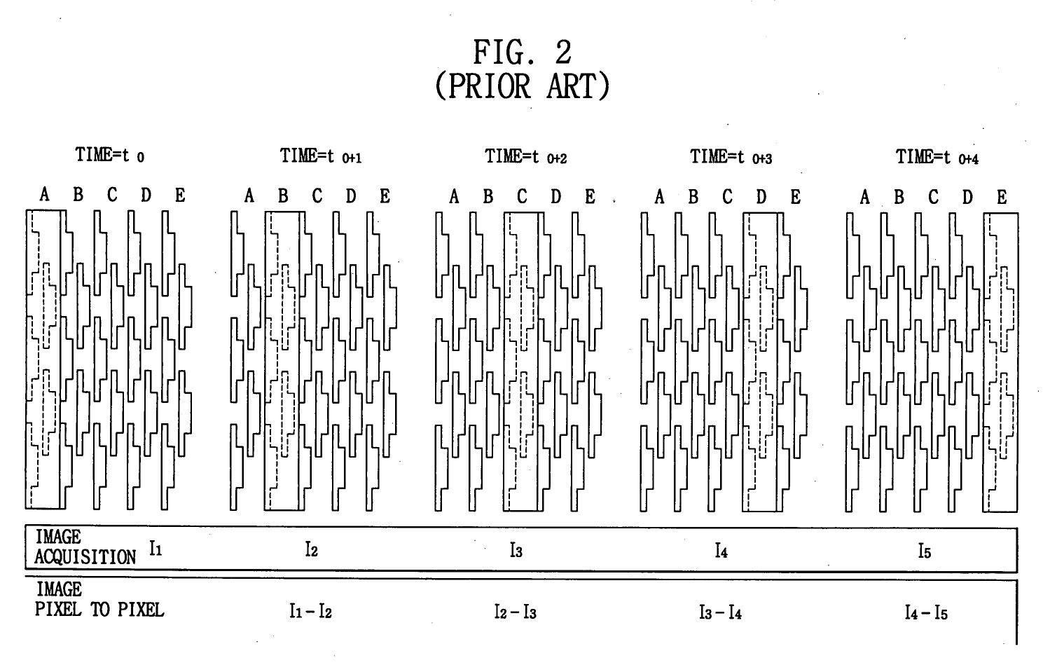

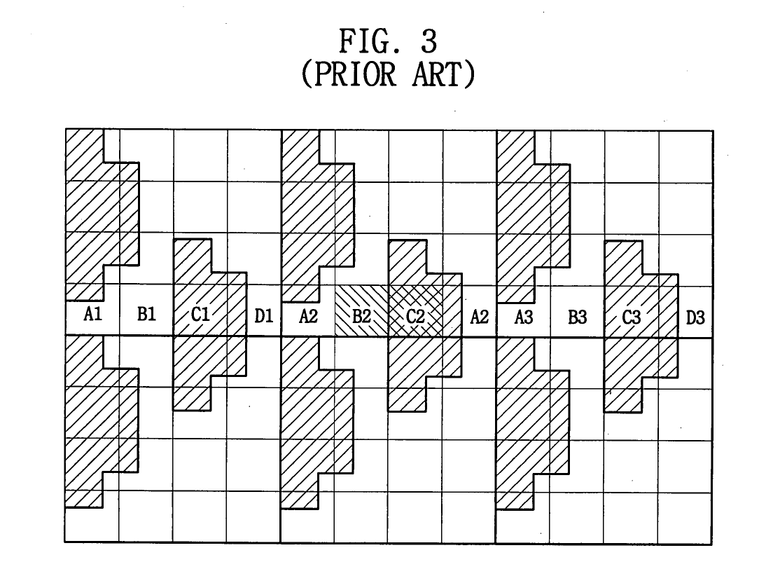

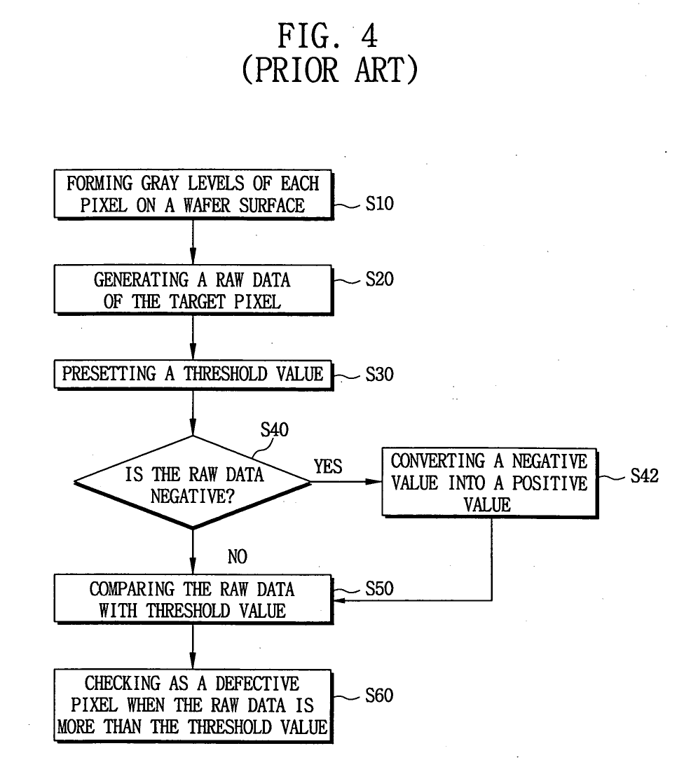

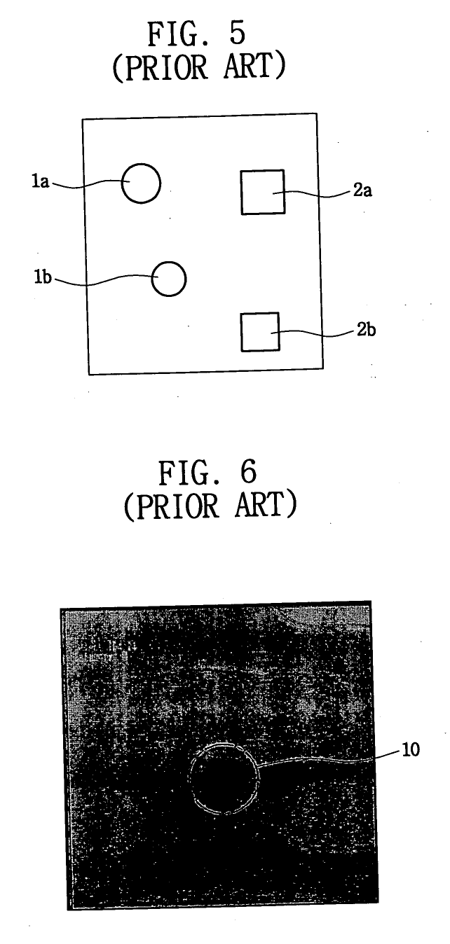

### DESCRIPTION OF THE PREFERRED EMBODIMENTS

The present invention now will be described more fully hereinafter with reference to the accompanying drawings, in which exemplary embodiments of the present invention are shown.

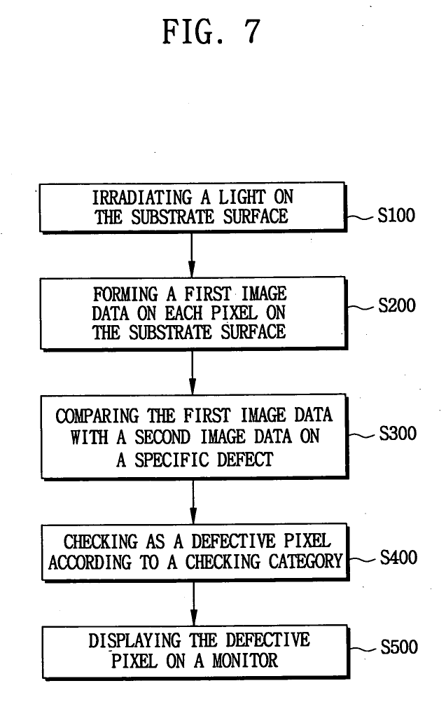

Referring to FIG. 7, a light is irradiated on a surface of the substrate on which a predetermined process has already been carried out so as to detect defects in step S100. A plurality of device units formed on the substrate surface may have the same pattern, and each of the device units includes a plurality of pixels. As an exemplary embodiment, the substrate may be a wafer for fabricating a semiconductor device, and the device unit may be a unit cell operating as an independent electronic circuit on the wafer. The light may have a relatively short wavelength, i.e., a short-wave light. Therefore, the light is relatively well reflected and hardly diffracts or interferes on the substrate surface. For example, an ultraviolet light may be irradiated on the substrate surface.

In next step S200, first image data on each pixel is formed by the cell through sensing the light reflected from the substrate surface. As an exemplary embodiment, the reflected light may be received by a photo-sensor, and detected by a detecting unit to form analog image data for each of the pixels. The analog image data is stored for every device unit, and may be converted into digital image data using the ADC. As an exemplary embodiment, the digital image data may be expressed as a gray scale distinguishable by a relative density of black and white. The gray scale may be divided into 256 different levels by using an 8-bit microprocessor. Hereinafter, one of the 256 levels of the gray scale is referred to as a gray level.

Subsequently, the first image data is compared with second image data on a specific defect in step S300. As an exemplary embodiment, reviewing or observing the surface of the substrate may generate the second image data. In this respect, various instruments such as an optical instrument and an electromagnetic instrument are used to schematically review or observe the substrate surface. Accordingly, the digital image data is extracted from the specific defect distinguishable from other defects on the substrate surface. For example, an optical microscope or a scanning electron microscope (SEM) may produce the digital image data on the specific defect. The digital image data on the specific defect is also expressed as a gray scale that can be divided into different 256 levels due to the 8-bit microprocessor. Therefore, the first image data is compared with the second image data in a binary digit unit. The second image data may be a specific binary digit, or may be a range defined by upper and lower limits. When the second image data is expressed as the range, all of the defects included into the above range are detected.

Then, when the first image data satisfies a checking criterion with regard to the second image data, a pixel corresponding to the first image data is checked as a defective pixel in step 400. That is, when the first image data is substantially identical to the second image data, the pixel corresponding to the first image data is checked as a defective pixel, or when the first image data is within the range of the second image data, the pixel corresponding to the first image data is checked as a defective pixel. Accordingly, only a pixel satisfying the checking criterion can be detected during the inspection process, thus the present invention can prevent various defects from being detected together. In addition, the present invention can advantageously detect only the specific defect. If the detected defect is different from the specific defect, the second image data is corrected and reset into the image data corresponding to the specific defect. Then, the above-mentioned comparison process is repeatedly performed. As an exemplary embodiment, the defective pixel and a defect image corresponding to the second image data are displayed on a monitor in step S500, so that the defect of a pixel can be visually shown.

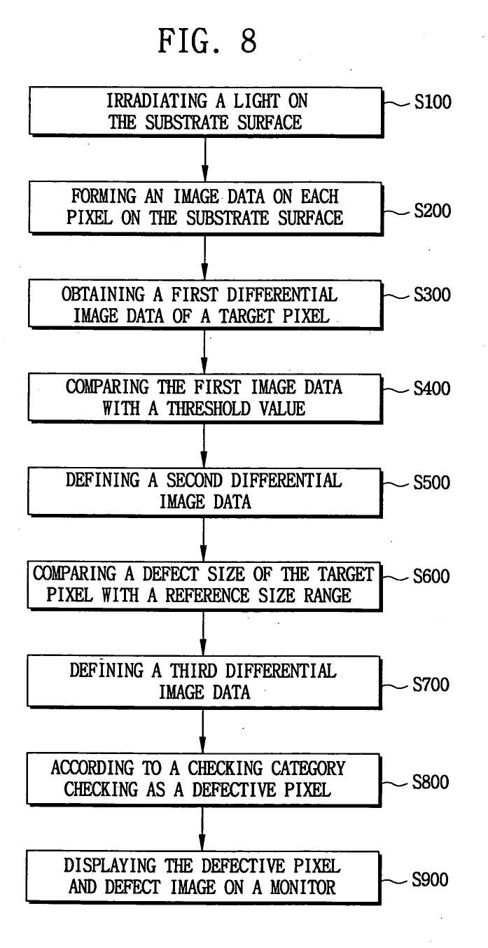

Referring to FIG. 8, a light is irradiated on a surface of the substrate on which a predetermined process has already been carried out so as to detect defects in step S100. A plurality of device unit is formed on the substrate surface may have the same pattern, and each of the device units includes a plurality of pixels. As an exemplary embodiment, the substrate may be a wafer for fabricating a semiconductor device, and the device unit may be a unit cell operating as an independent electronic circuit on the wafer. The light may have a relatively short wavelength, i.e., a short-wave light. Therefore, the light is relatively well reflected and hardly diffracts or interferes on the substrate surface. For example, an ultraviolet light may be irradiated on the substrate surface.

Next, image data on each pixel is formed for each cell by sensing a reflecting light reflected from the substrate surface in step S200. As an exemplary embodiment, the reflected light may be received by a photo-sensor, and detected by a detecting unit. As a result, analog image data on each of the pixels is formed. The analog image data is stored for every device unit, and may be converted into digital image data using the ADC. According to one embodiment, the digital image data may be expressed as a gray scale distinguishable by a relative density of black and white. The gray scale may be divided into 256 different levels by using an 8-bit microprocessor. Hereinafter, one of the 256 levels of the gray scale is referred to as a gray level.

Subsequently, first differential image data of a target pixel is obtained by subtracting the gray level of a corresponding pixel from the gray level of the target pixel in step S300. The target pixel is a subject pixel for detecting a defect. The corresponding pixel is a neighboring pixel that is positioned in a first device unit that is adjacent to a second device unit that includes the target pixel and that corresponds to the target pixel. Accordingly, when the wafer is normally processed, the corresponding pixel may have the same pattern as that of the target pixel even though the corresponding pixel and the target pixel are positioned on a different cell of the wafer with each other, and as a result, the gray level of the corresponding pixel is substantially identical to the gray level of the target pixel. Therefore, the discordance between the gray level of the target pixel and the gray level of the corresponding pixel indicates that the target pixel is a defective pixel. The gray level may be expressed as a binary digit system, and thus the difference between the gray levels is obtained by subtraction of the binary digit indicating the gray level. When it is a negative value, the first differential image data is converted into a positive value by taking an absolute value thereof. Therefore, the first differential image data is always a positive value.

In step S400, the first differential image data is compared with a preset threshold value. The threshold value is a kind of criterion value for determining defectiveness of the target pixel, and is also expressed as a binary digit to be compared with the first differential image data. In step S500, first differential image data greater than the threshold value becomes second differential image data. Because all of the pixels having first differential image data greater than the threshold value are checked as the defective pixel, all of the second differential image data are binary image data of the defective pixels. That is, the second differential image data includes all of the defects having a gray level difference greater than the threshold value. Therefore, all of the defects corresponding to the second differential image data greater than the threshold are usually detected together.

In next step S600, a defect size of the target pixel corresponding to the second differential image data is compared with a preset reference size range of a specific defect. The reference size range includes an upper limit and a lower limit, and each of the upper and lower limits indicates an area size over which the defect image extends on the substrate surface. In step S700, second differential image data of the target pixel of which the defect size is included in the reference size range becomes third differential image data. An empirical result reveals that most of the major killer defects in general have relatively unique area sizes, so that the reference size range corresponding to the area size of a specific defect, can be used to distinguish the specific defect from among the various defects by comparing the defect size with the reference size range. Therefore, the second differential image data is compared with the reference size range, and second differential image data within the reference size range becomes the third differential image data. As a result, the target pixel corresponding to the third differential image data has a defect of which the first differential image data is greater than the threshold value and of which the area size is within the reference size range. That is, the reference size range can distinguish the specific defect from among the various defects detected together, thereby improving promptness and accuracy of the detecting process.

The target pixel corresponding to the third differential image data is checked as a defective pixel in step S800, and the defective pixel and a defective image thereof is displayed on a monitor for visual observation, thus the defect type is visually verified.

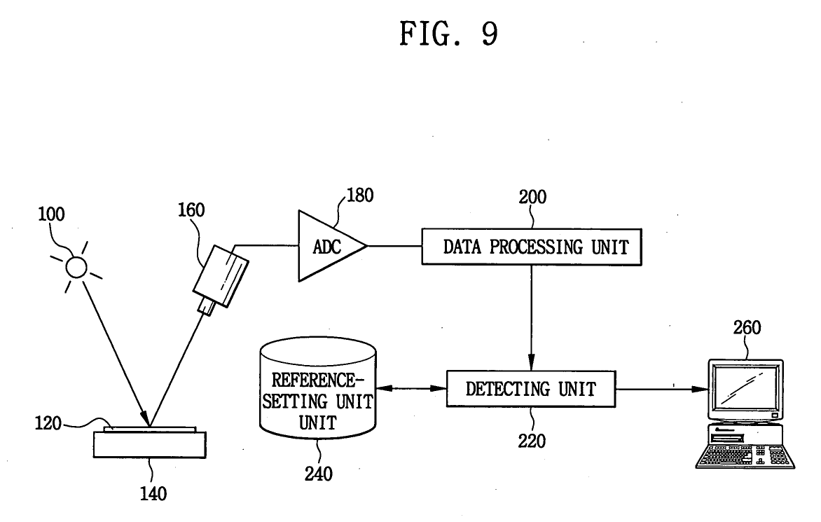

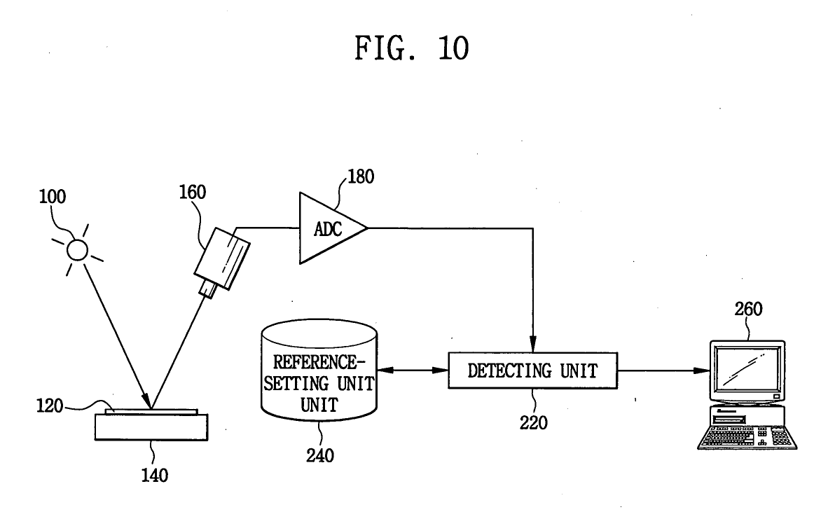

Referring to FIG. 9, an apparatus for detecting a defect according to the first embodiment of present invention includes a support 140 for supporting a substrate 120 on which a predetermined process has already been carried out. For example, the substrate 120 may be a wafer for fabricating a semiconductor undergone a chemical mechanical polishing (CMP) process, an etch-back process, a contact process, or an etching process.

A plurality of device units formed on the substrate surface may have the same pattern, and each of the device units includes a plurality of pixels. When the substrate is a wafer for fabricating a semiconductor device, the device unit is a unit cell operating as an independent electronic circuit on the wafer. The conventional loading system such as a robot arm may be used for loading/unloading the wafer to/from the support. Hereinafter, the apparatus for detecting a defect according to the present invention is exemplarily described with regard to the wafer for fabricating a semiconductor device and the cell on the wafer, however, the present invention is not limited to the wafer for fabricating a semiconductor device, as is apparent to one skilled in the art.

A light is irradiated from the light source 100 onto a surface of the wafer 120 positioned on the support 140, and reflected from the wafer surface. An image detector 160 including a photo-sensor detects the reflected light, and generates analog image data of every pixel on the device unit.

An analog-to-digital converter 180 transforms the analog image data into digital image data. As an exemplary embodiment, the digital image data may be expressed as a gray scale distinguishable by a relative density of black and white. The gray scale is divided into 256 different levels by using an 8-bit microprocessor, thus the pixel has a level among the 256 different levels, which is referred to as a gray level corresponding to the pixel. Accordingly, when the gray level is obtained for every pixel of the cell, all of the gray levels constitute the digital image data of the cell as a whole. When the digital image data of each cell on the wafer is obtained, an image map for a wafer is formed.

A data processing unit 200 generates first differential image data of a target pixel by subtracting the gray level of a corresponding pixel from the gray level of the target pixel. The target pixel is a subject pixel for detecting a defect. The corresponding pixel is a neighboring pixel that is positioned in a first device unit that is adjacent to a second device unit that includes the target pixel, and that corresponds to the target pixel.

A reference-setting unit 240 presets a threshold value and a reference size range. The threshold value is compared with the first differential image data of the target pixel, and is a criterion for determining defectiveness of the target pixel. The reference size range is criterion for distinguishing a specific defect having a particular image size from among the various defects of which the first differential image data is greater than the threshold value, and includes an upper limit and a lower limit. Each of the upper and lower limits indicates an area size over which the defect image extends on the substrate surface. An empirical result reveals that most of the major killer defects usually have relatively unique area sizes, so that the reference size range corresponding to the area size of a specific defect, which needs to be investigated, can be used to distinguish the specific defect from among the various defects by comparing the defect size with the reference size range. As an exemplary embodiment, a plurality of the reference size ranges may be preset so as to distinguish a plurality of defects from among the detected defects.

A detecting unit 220 detects and checks out the specific defect on the wafer surface by using the preset threshold value and the reference size range. Firstly, the detecting unit 220 compares the first differential image data of the target pixel with the threshold value, and defines first differential image data greater than the threshold value as second differential image data. Because the threshold value and the first differential image data are expressed as digital binary digits, the first differential image data and the threshold value are compared and operated in the binary system. A plurality of defects on the target pixel corresponding to first differential image data greater than the threshold value are detected together, so that second differential image data is obtained in the detecting unit 220. Then, each of the image size corresponding to the respective second differential image data is compared with the reference size range, and third differential image data is generated, which is second differential image data within the reference size range. That is, the defect on the target pixel has the differential image data greater than the threshold value and the image size within the reference size range. Accordingly, the reference size range of the present embodiment of the present invention can distinguish the specific defect from the various defects detected together, thereby improving promptness and accuracy of the defect detecting process. The detecting unit 220 includes a CPU and a co-coprocessor, which is an auxiliary processor for supporting the CPU during a numerical operation, and is operated by a main program and a plurality of sub-programs. The detecting unit 220 checks the target pixel corresponding to the third differential image data as a defective pixel. Finally, the defective pixel is displayed on a monitor 260 for visual observation, thus visually verifying the defect type.

Referring to FIG. 10, an apparatus for detecting a defect includes a support 140 for supporting a substrate 120 on which a predetermined process has already been carried out. For example, the substrate 120 may be a wafer for fabricating a semiconductor undergone a CMP process, an etch-back process, a contact process, or an etching process.

A plurality of device units formed on the substrate surface may have the same pattern, and each of the device units includes a plurality of pixels. When the substrate is a wafer for fabricating a semiconductor device, the device unit is a unit cell operating as an independent electronic circuit on the wafer. The conventional loading system such as a robot arm may be used for loading/unloading the wafer to/from the support. Hereinafter, the apparatus for detecting a defect according to the present invention is exemplarily described with regard to the wafer for fabricating a semiconductor device and the cell on the wafer, however, the present invention is not limited to the wafer for fabricating a semiconductor device, as is apparent to one of the ordinary skill in the art.

A light is irradiated on a surface of the wafer 120 positioned on the support 140 from the light source 100, and reflected from the wafer surface. An image detector 160 including a photo-sensor detects the reflected light, and generates analog image data of every pixel on the device unit.

An analog-to-digital converter 180 transforms the analog image data into digital image data. As an exemplary embodiment, the digital image data may be expressed as a gray scale that is distinguishable by a relative density of black and white. The gray scale is divided into 256 different levels by using an 8-bit microprocessor, thus the pixel has a level among the 256 different levels, which is referred to as a gray level corresponding to the pixel. Accordingly, when the gray level is obtained for every pixel of the cell, all of the gray levels constitute the digital image data of the cell as a whole. When the digital image data of each cell on the wafer is obtained, an image map for a wafer is formed.

A reference-setting unit 240 presets digital image data on a specific defect that needs to be investigated. According to one embodiment, the second image data may be generated by reviewing or observing the substrate surface. In this respect, various instruments such as an optical instrument and an electromagnetic instrument are used to review or observe the substrate surface. Accordingly, the second image data on the specific defect clearly distinguishable from other defects can be drawn out from among the defects generated on the substrate surface. More particularly, an optical microscope or a SEM may produce digital image data on the specific defect. The second image data on the specific defect may be also expressed as a gray scale of binary digit that can be divided into different 256 levels due to the 8-bit microprocessor. Therefore, the first image data is compared with the second image data in a binary digit unit. The second image data may be a specific binary digit, or may be a range defined by upper and lower limits.

A detecting unit 220 compares the first image data with the second image data, and checks the pixel corresponding to the first image data as a defective pixel when the first image data satisfies a checking criterion with regard to the second image data. The detecting unit 220 includes a CPU and a co-coprocessor, which is an auxiliary processor for supporting the CPU during a numerical operation, and is operated by a main program and a plurality of sub-programs. The defective pixel is displayed on a monitor 260 for visual observation, thus visually verifying the defect type. Accordingly, the detecting apparatus according to the first embodiment of the present invention can determine whether or not the specific defect is founded on a target pixel by just using the digital image data on the target pixel without comparing with the digital image data on a corresponding pixel. The target pixel is a subject pixel for detecting a defect. The corresponding pixel is a neighboring pixel that is positioned in a first cell that is adjacent to a second cell that includes the target pixel, and that corresponds to the target pixel.

In view of the above exemplary embodiments of the present invention, the gray level itself or image size of a specific defect on a pixel of the wafer surface can prevent the specific defect from being detected together with other defects, so that the defect on the wafer surface is more promptly and accurately detected, thereby improving the throughput of the semiconductor device fabrication.

Although the above exemplary embodiments discuss the method and apparatus for detecting a defect in the array mode, the method and apparatus disclosed could also be applicable in the random mode known to one of the ordinary skill in the art, since both of the array and the random mode are based on the comparison so as to detect a defect on the wafer.

Although the exemplary embodiments of the present invention have been described, it is understood that the present invention should not be limited to these exemplary embodiments but various changes and modifications can be made by one skilled in the art within the spirit and scope of the present invention as hereinafter claimed.

What is claimed is:

1. A method of detecting a defect on a substrate, the method comprising:
irradiating a light on a substrate, wherein the substrate has a plurality of device units formed on a surface of the substrate and each device unit includes a plurality of pixels;
forming first image data for each pixel on each device unit by sensing the light reflected from the substrate surface;
forming second image data of a specific defect;
comparing the first image data with the second image data;
marking a pixel corresponding to the first image data as a defective pixel when the first image data corresponds to the second image data.

2. The method of claim 1, wherein the substrate includes a wafer for fabricating a semiconductor device and the device unit further comprises a unit cell operating as an independent electronic circuit on the wafer.

3. The method of claim 1, wherein the irradiating light includes a short-wave light.

4. The method of claim 4, wherein the short-wave light includes an ultraviolet light.

5. The method of claim 1, wherein the image data includes binary digital data.

6. The method of claim 5, wherein the binary digital data represents a level on a gray scale, wherein the gray scale is distinguishable by a relative density of black and white.

7. The method of claim 6, wherein the gray scale is divided into 256 different levels.

8. The method of claim 1, wherein forming second image data of a specific defect comprises observing the substrate surface.

9. The method of claim 8, wherein observing the substrate surface comprises using an optical or electromagnetic instrument.

10. The method of claim 9, wherein the electromagnetic instrument includes a scanning electron microscope (SEM).

11. The method of claim 1, wherein the second image data includes a particular digit and marking a pixel corresponding to the first image data as a defective pixel when the first image data is substantially identical to the second image data.

12. The method of claim 1, wherein the second image data includes a range defined by upper and lower limits and marking a pixel corresponding to the first image data as a defective pixel when the first image data is substantially identical to the second image data.

13. The method of claim 1, further comprising displaying the defective pixel and a defect image on a monitor.

14. The method of claim 1, wherein the plurality of device units have the same pattern.

15. A method of detecting a defect on a substrate comprising:
irradiating a light on a substrate, wherein the substrate has a plurality of device units formed on a surface of the substrate and each device unit includes a plurality of pixels;
forming image data for each of the pixels on each device unit by sensing the light reflected from the surface of the substrate;
forming first differential image data of a target pixel by subtracting the image data of a corresponding pixel from the image data of the target pixel, wherein the target pixel is a subject pixel for detecting a defect and the corresponding pixel is positioned in a first device unit adjacent to a second device unit that includes the target pixel, wherein the corresponding pixel corresponds to the target pixel;
comparing the first differential image data with a preset threshold value;
forming second differential image data of the target pixel when the first differential image data of the target pixel is greater than the threshold value;
comparing a defect size of the second differential image data of the target pixel with a reference size range of a specific defect;
forming a third differential image data of the target pixel when the second differential image data of the target pixel is within the reference size range of the specific defect; and
marking the target pixel corresponding to the third differential image data as a defective pixel.

16. The method of claim 15, wherein the substrate includes a wafer for fabricating a semiconductor device and the device unit further comprises a unit cell operating as an independent electronic circuit on the wafer.

17. The method of claim 15, wherein the irradiating light includes a short-wave light.

18. The method of claim 17, wherein the short-wave light includes an ultraviolet light.

19. The method of claim 15, wherein the image data includes binary digital data.

20. The method of claim 19, wherein the binary digital data represents a level on a gray scale, wherein the gray scale is distinguishable by a relative density of black and white.

21. The method of claim 15, further comprising displaying the defective pixel and a defect image on a monitor.

22. The method of claim 15, wherein the plurality of devices units have the same pattern.

23. An apparatus for detecting a defect on a substrate, the apparatus comprising:
a support for supporting a substrate, wherein the substrate has a plurality of device units with a same pattern formed on a surface of the substrate and each device unit includes a plurality of pixels;
a light source for irradiating a light on the substrate;
an image detector for sensing light reflected by a surface of the substrate from the light source, wherein the image detector generates analog image data for each pixel of each device unit;
an analog-to-digital converter for converting the analog image data to digital image data;
a reference setting unit for setting a threshold value and a reference size range;
a data processing unit for forming first differential image data of a target pixel by subtracting the digital image data of a corresponding pixel from the digital image data of the target pixel, the target pixel being a subject pixel for detecting a defect, and the corresponding pixel being a neighboring pixel that is positioned in a first device unit adjacent to a second device unit including the target pixel and that corresponds to the target pixel;
a reference setting unit for setting a threshold value and a reference size range, the threshold value being compared with the first differential image data and the reference size range being compared with a defect size corresponding to a specific defect; and
a checking unit for checking a defective pixel, whereby the first differential image data becomes second differential image data of the target pixel if the first differential image data is greater than the threshold value, and the second differential image data of the target pixel becomes third differential image data of the target pixel, if the second differential image data of the target pixel is within the reference size range, the checking unit checking the target pixel corresponding to the third differential image data as the defective pixel.

24. The apparatus of claim 23, wherein the substrate is a wafer for fabricating a semiconductor device and the plurality of device units are unit cells operating as independent electronic circuits on the wafer.

25. The apparatus of claim 23, wherein the light of the light source includes a short-wave light.

26. The apparatus of claim 23, wherein the short-wave light includes an ultraviolet light.

27. The apparatus of claim 23, wherein the digital image data is expressed as a gray scale distinguishable by a relative density of black and white.

28. The apparatus of claim 23, further comprising a monitor for displaying the defective pixel and a defect image.

29. An apparatus for detecting a defect on a substrate, the apparatus comprising:
a support for supporting a substrate, wherein the substrate has a plurality of device units with a same pattern formed on a surface of the substrate and each device unit includes a plurality of pixels;
a light source for irradiating a light on the substrate;
an image detector for sensing light reflected by a surface of the substrate from the light source;
a reference setting unit for setting a threshold value, wherein the threshold value is digital image data of a specific defect; and
a marking unit for marking a pixel as defective when the digital image data of the pixel is substantially identical to the threshold value.

30. The apparatus of claim 29, wherein the digital image data is expressed as a gray scale distinguishable by a relative density of black and white.

31. The apparatus of claim 29, further comprising a monitor for displaying the defective pixel and a defect image.

32. The apparatus of claim 29, wherein the image detector generates analog image data for each pixel of each device unit, further comprising an analog-to-digital converter for converting the analog image data to digital image data.
